(19) United States
(12) Patent Application Publication
(10) Pub. No.: US 2007/0208282 A1
(43) Pub. Date: Sep. 6, 2007

(54) Body shaking device

(76) Inventors: Cheng-Hsun Huang, Wuci Township (TW); Yu-Chu Chen, Wuci Township (TW); David Shih, Wuci Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/491,091

(22) Filed: Jul. 24, 2006

(30) Foreign Application Priority Data
Mar. 3, 2006 (TW) 095107276
Jun. 7, 2006 (TW) 095120210

(51) Int. Cl. A61H 1/02; A61H 7/00; A61H 1/00

(52) U.S. Cl. 601/30; 601/23; 601/98

(57) ABSTRACT

A body shaking device includes a base with a driving unit received therein which drives two eccentric shafts. Each eccentric shaft is connected with a transmission unit which includes a first plate and a second plate which is located higher than the first plate. The two transmission units are pivotable at two respective pivotal points so that two ends of the two transmission units are moved up and down. A plurality of support members are connected to the transmission units and a case is mounted onto the base and supported by the support members. The user stands on the case which is moved up and down at different speeds so as to shank the user's body.

### FIELD OF THE INVENTION

The present invention relates to a body or limb shaking device which provides whole body shaking feature to improve blood circulation.

### BACKGROUND OF THE INVENTION

A conventional body or limb shaking device 50 is shown. in FIGS. 10, 11, 12A and 12B, and generally includes a top board 51 which is supported by a link 56 and the link 56 has one end pivotably connected to an eccentric wheel 55. The eccentric wheel 55 is driven by belt 54 which is connected to a driving wheel 53 which is connected to a motor 52. When the motor 52 is activated, the driving wheel 53 drives the belt 54 which rotates the eccentric wheel 55 so that the link 56 pushes the top board 51 up and down about a pivotal point at an other end of the top board 51 away from the link 56. By the movement of the top board 51, the user's limb or body shakes. However, the conventional shaking device 50 can provide only a limited shaking mode and cannot meet needs of different users.

The present invention intends to provide a limb or body shaking device that provides a wide range of shaking to simulate the oriental Chi exercise which shakes the user's whole body.

### SUMMARY OF THE INVENTION

The present invention relates to a body shaking device comprising a base with a driving unit connected thereto and two eccentric shafts are driven by the driving unit. Two transmission units are connected with the two eccentric shafts respectively and each. transmission unit includes a first plate and a second plate. The first and second plates are pivoted about two respective pivotal points. A plurality of support members are connected to the transmission units and a case is mounted onto the base and supported by the support members. The case shakes when the driving unit is activated and the user's body is in contact with the case and shaken by the shaking case.

The primary object of the present invention is to provide a body shaking device that provides various types of shaking modes to meet needs of different users.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the body shaking device of the present invention;

FIG. 2A is an exploded view to show the base and the casing of the body shaking device of the present invention;

FIG. 2B is an exploded view to show the base and the transmission unit of the body shaking device of the present invention;

FIG. 2C is an exploded view to show the transmission unit of the body shaking device of the present invention;

FIG. 3 is a side view of the body shaking device of the present invention;

FIGS. 4A to 4C show that the transmission unit is activated by the eccentric shafts;

FIGS. 5 and 6 show a user standing on the case and the body shaking device shakes the user's body;

FIGS. 7 and 8 show that two embodiments of the transmission unit of the present invention;

FIG. 9 shows cushion pads are cooperated with the transmission unit of the present invention;

FIG. 10 is a perspective view to show a conventional body shaking device;

FIG. 11 is a side cross sectional view of the conventional body shaking device, and FIGS. 12A and 12B show the movement of the case of the conventional body shaking device.

### DETAILED DESCRIPTION OF THE PREFERRED EMBODIMENT

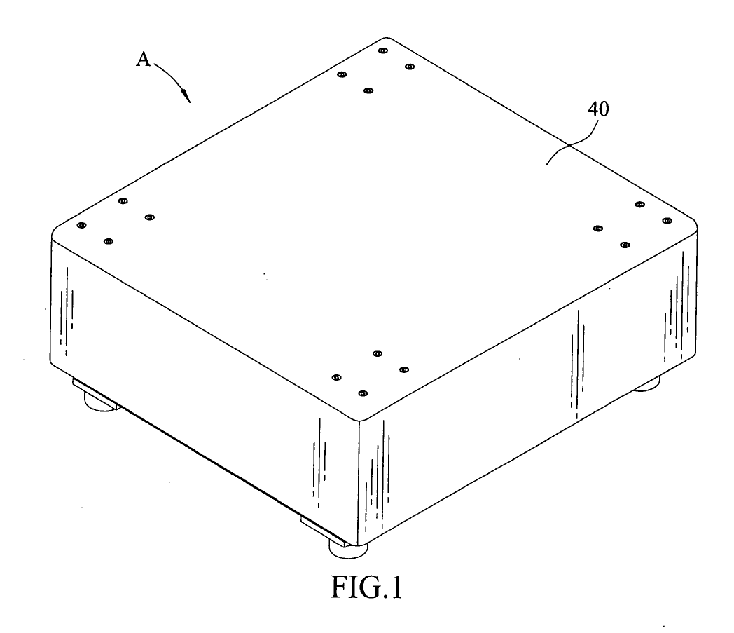

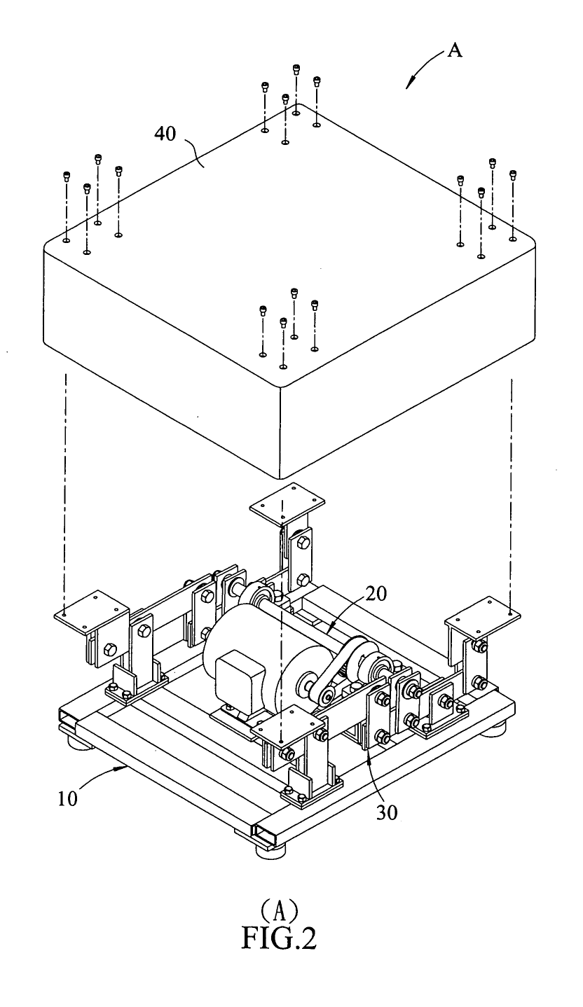

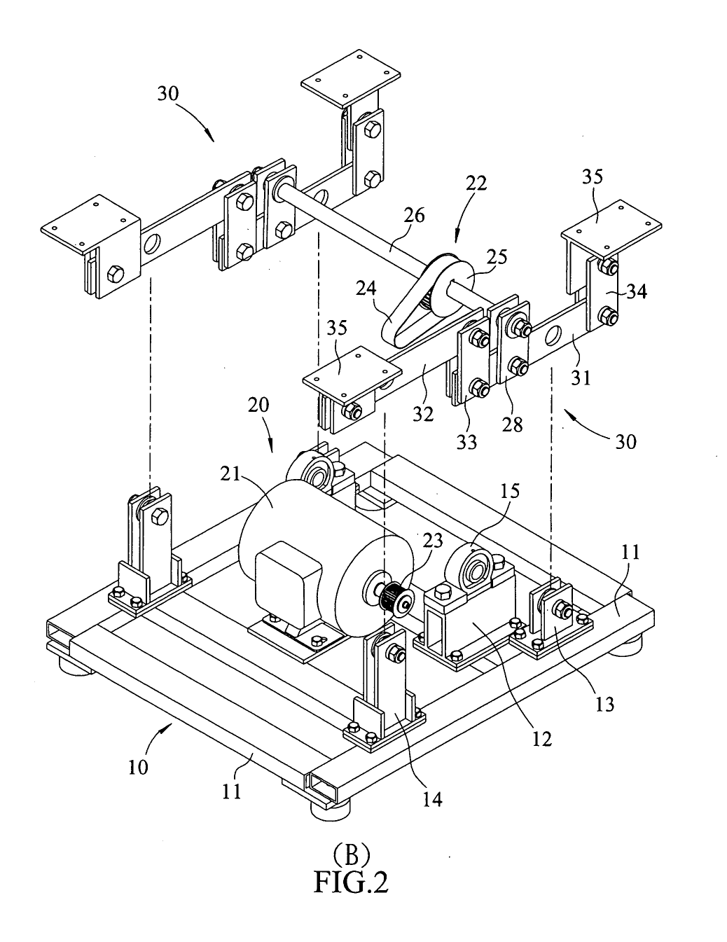

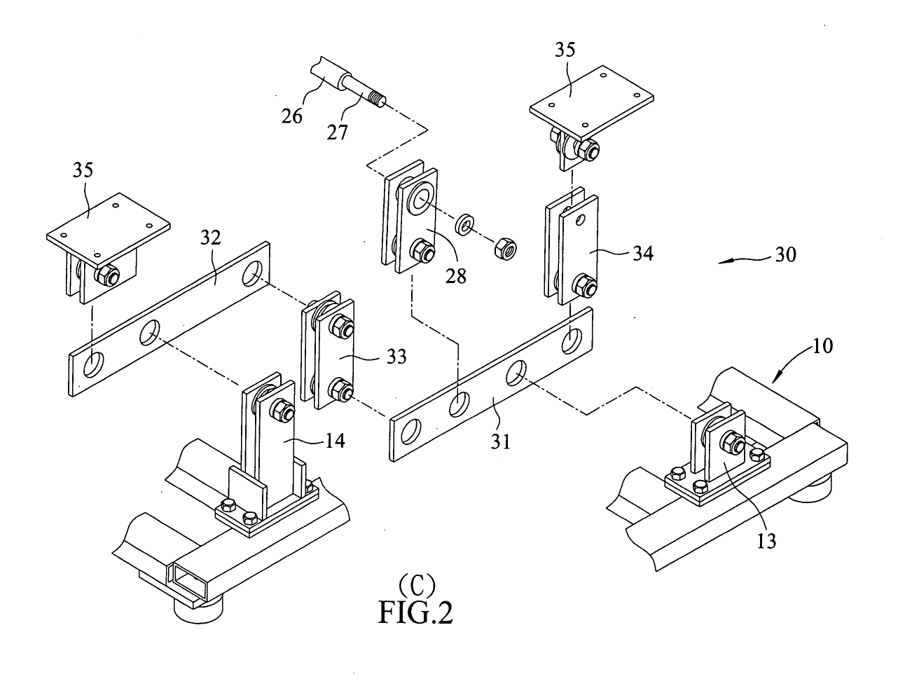

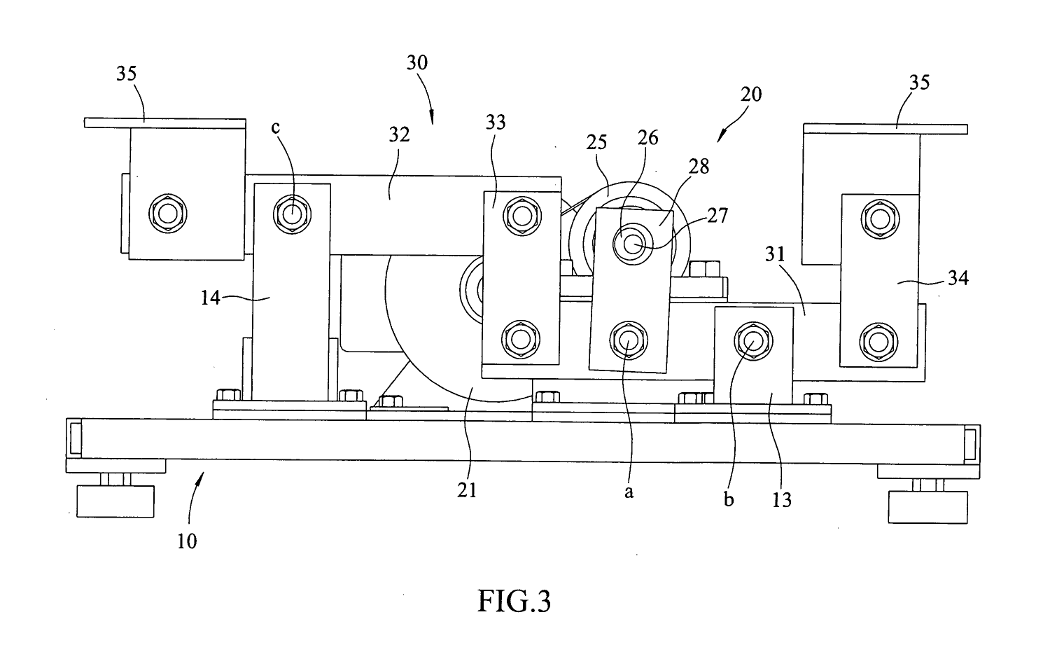

Referring to FIGS. 1, 2A, 2B, 2C, and 3, the body shaking device “A” of the present invention comprises a base 10 which is composed of a plurality elongate boards 11 which are connected with each other to form a rectangular base. Two first pivotal frames 13 and two second pivotal frames 14 are fixed on two sides of the base 10 and a fixed frame 12 is connected to the base 10 and a bearing 15 is connected on the fixed frame 12.

A driving unit 20 is connected to the base 10 and includes a motor 21, a driving shaft 26 driven by the motor 21 and two transmission members 28. The motor 21 has an output shaft on which a driving wheel 23 is connected. A belt is connected between the driving wheel 23 and a transmission wheel 25 on the driving shaft 26 so as to form a transmission unit 22. The driving shaft 26 extends through the bearing 15. Two eccentric shafts 27 extend from two ends of the driving shaft 26 and the two transmission members 28 each have one end pivotably connected the two eccentric shafts 27. The two eccentric shafts 27 are driven by the driving unit 20.

Two transmission units 30 are connected with the two eccentric shafts 27 respectively and each transmission unit 30 includes a first plate 31 and a second plate 32. The other end of each transmission member 28 is pivotably connected to the first plate 31 corresponding thereto at a pivotal point “a”. The first and second plates 31, 32 are pivoted about two respective pivotal points “b” and “c”. The first plates 31 of the transmission units 30 are pivotably connected to the first pivotal frames 13 at the pivotal points “b” and the second plates 32 are pivotably connected to the second pivotal frames 14 at the pivotal points “c”. The first plates 31 and the two second plates 32 are located at different height relative to the base 10, wherein the second plates 32 are located higher than the first plates 31. Two first connection members 33 each are connected between two respective first ends of the first and second plates 31, 32. A plurality of support members 35 connected to the second ends of the first and second plates 31, 32 of the transmission units 30.

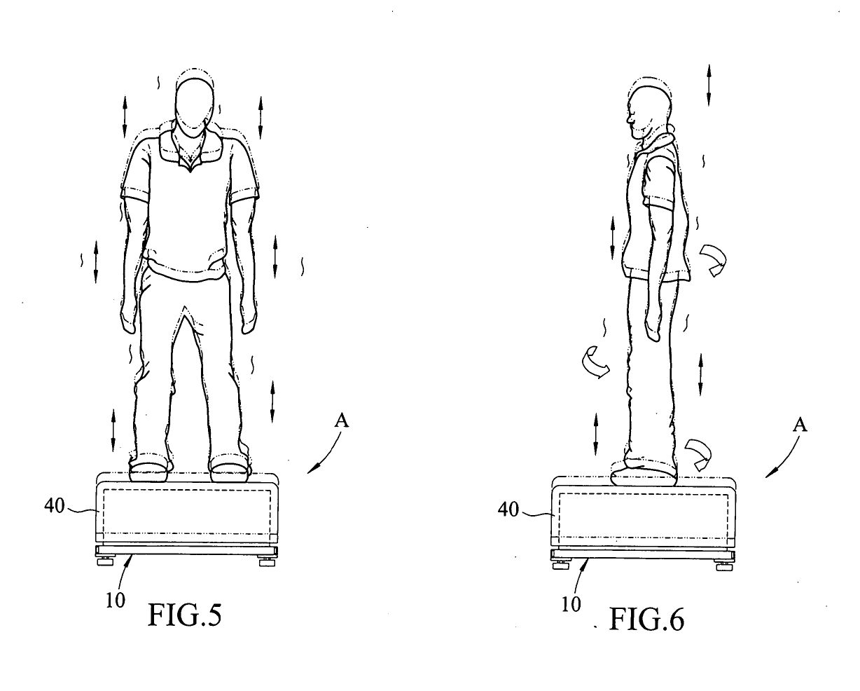

The support members 35 each have a second connection member 34 which is pivotably connected to the second ends of the first plates 31 and the second plates 32. Each second connection member 34 has a flat top. A case 40 is mounted onto the base 10 and supported by the flat tops of the support members 35. The user can stand on the case 40 or put a limb on the case 40 as shown in FIGS. 5 and 6.

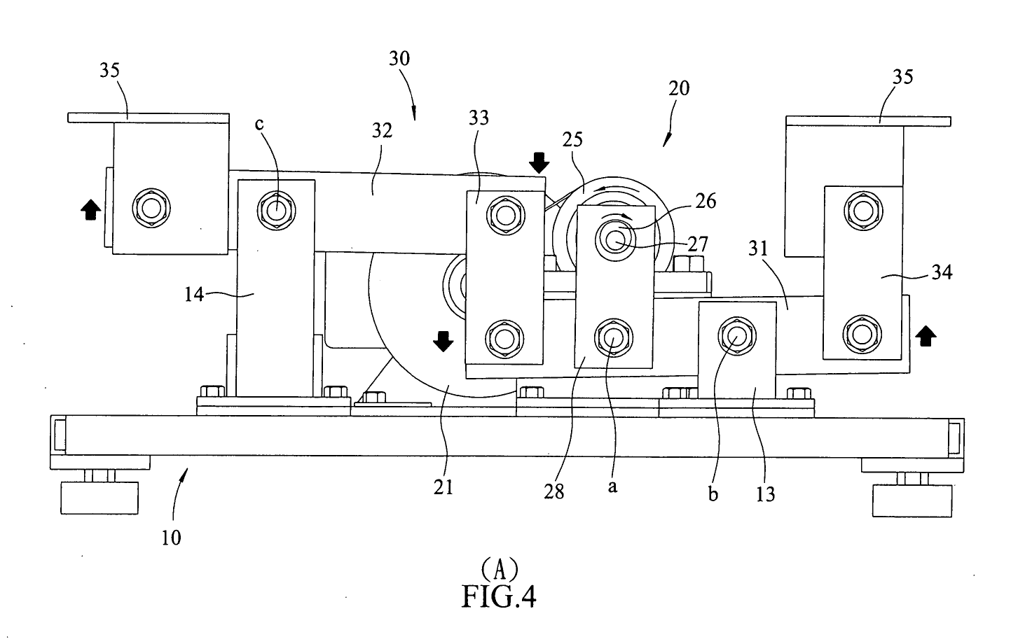

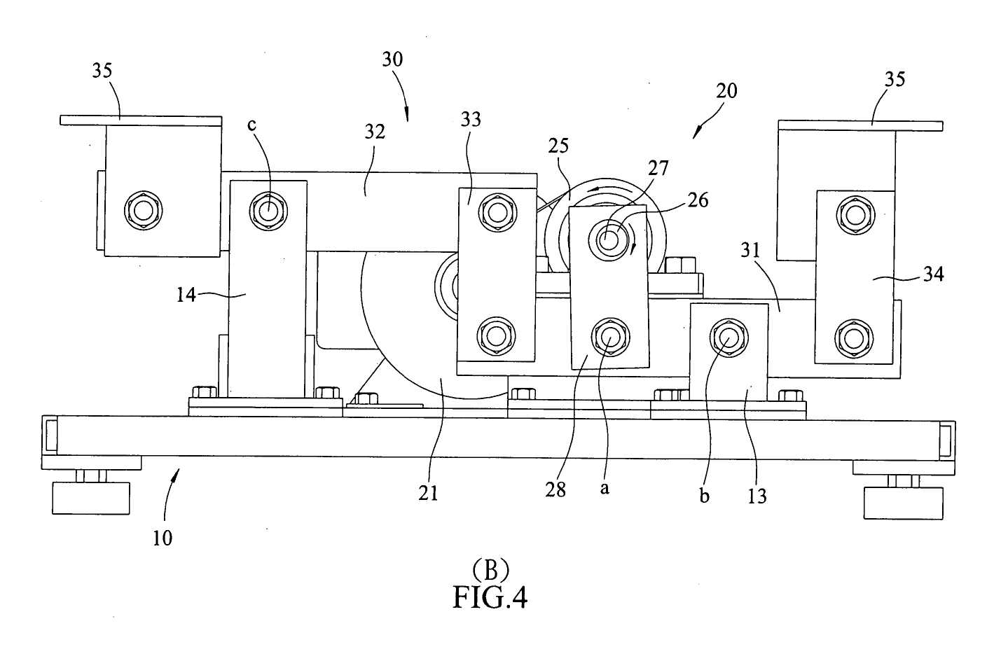

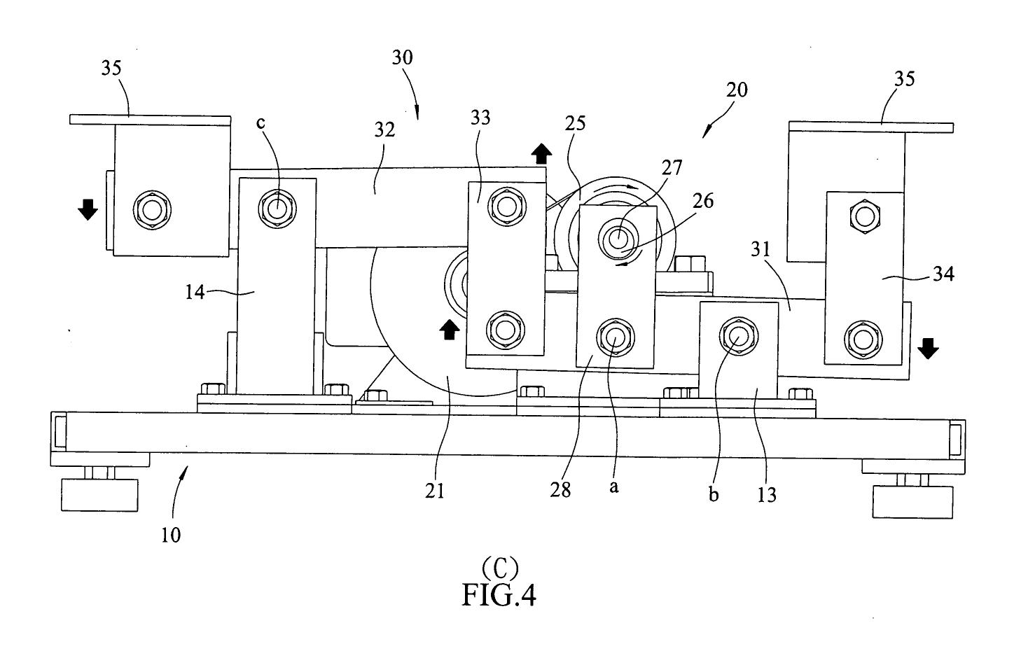

As shown in FIGS. 4A to 4C, when the motor 21 is activated, the two eccentric shafts 27 are rotated and move the two transmission members 28 which then pivot the first plates 31 about the pivotal point “b”. The first plates 31 are pivotably connected to the second plates 32 by the first connection members 33, so that the second plates 32 are pivoted about the pivotal points “c”. Therefore, the supports members 35 together with the case 40 are moved up and down as shown in FIGS. 5 and 6.

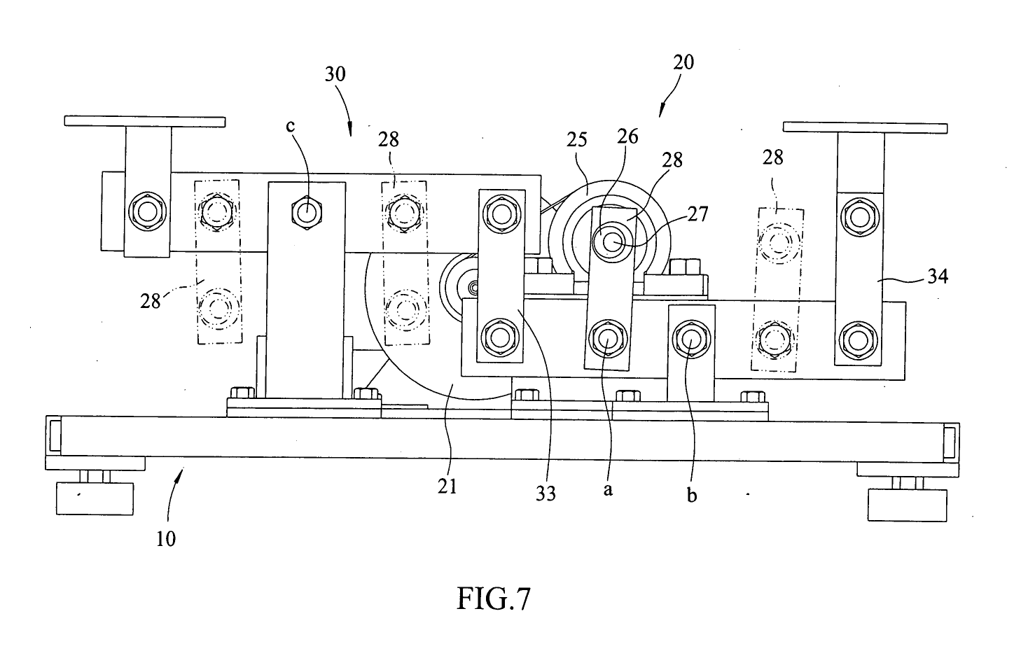

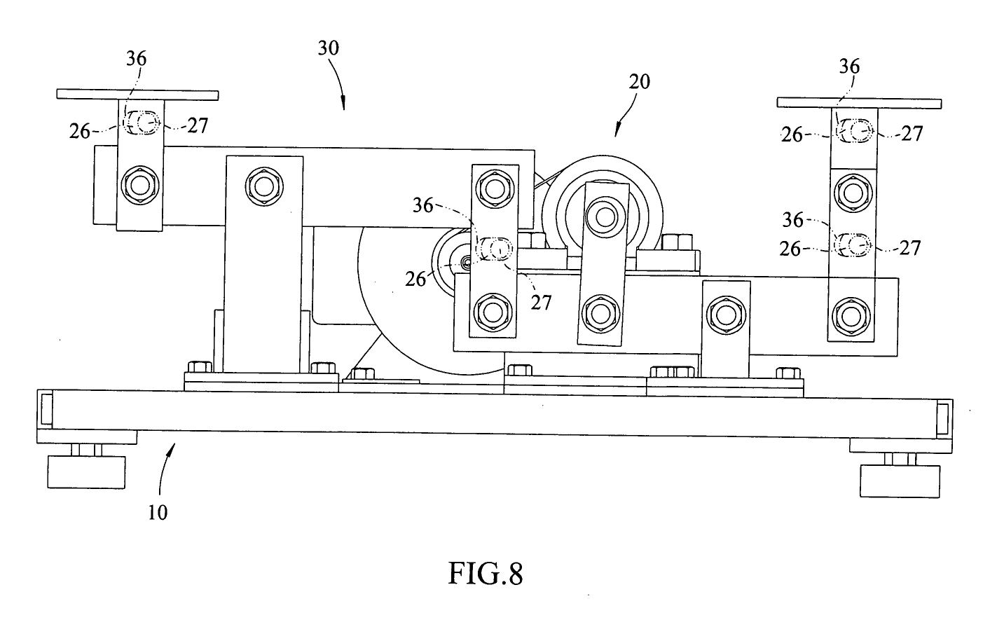

It is noted that the transmission members 28 can be connected to the first or second plates 31 or 32 at desired positions as shown in FIG. 7 to create different types of movements. As shown in FIG. 8, each of the first connection members 33, or the second connection members 34 may have a slot 36 defined therethrough and each slot 36 is engaged with an eccentric shaft 27 driven by the motor 21. By these arrangements, the types of the movements of the case 40 can be varied.

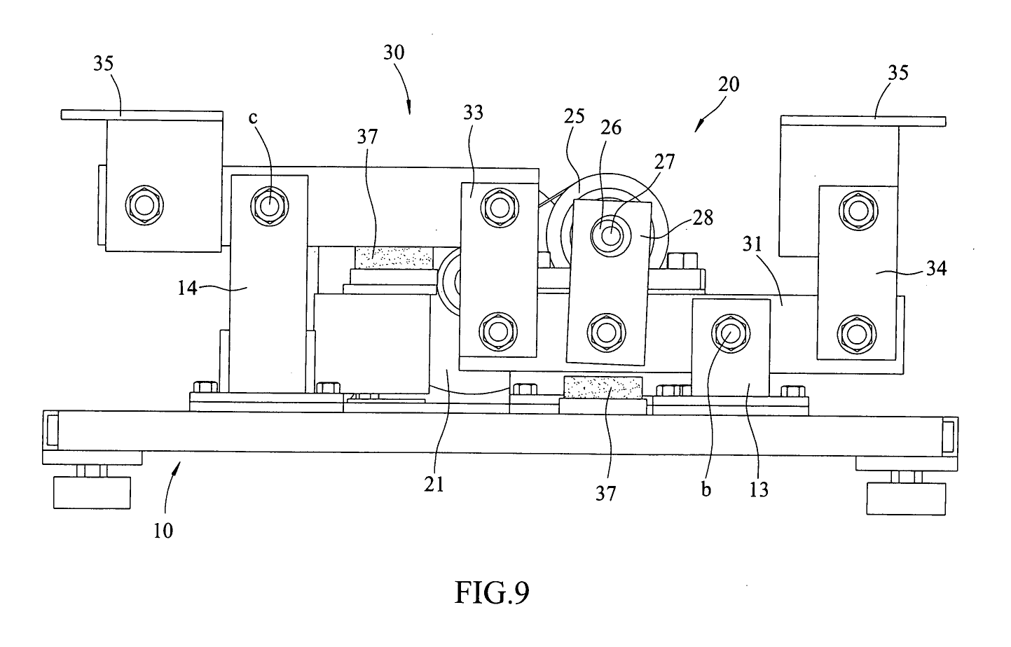

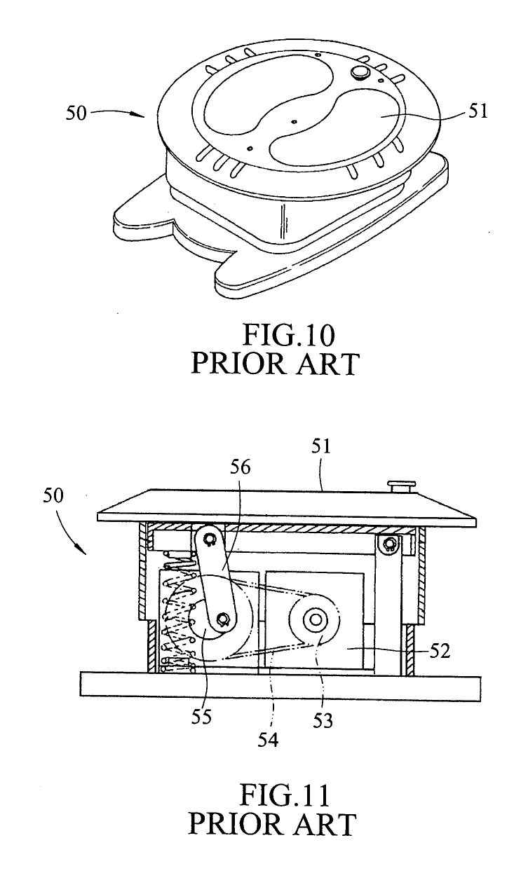

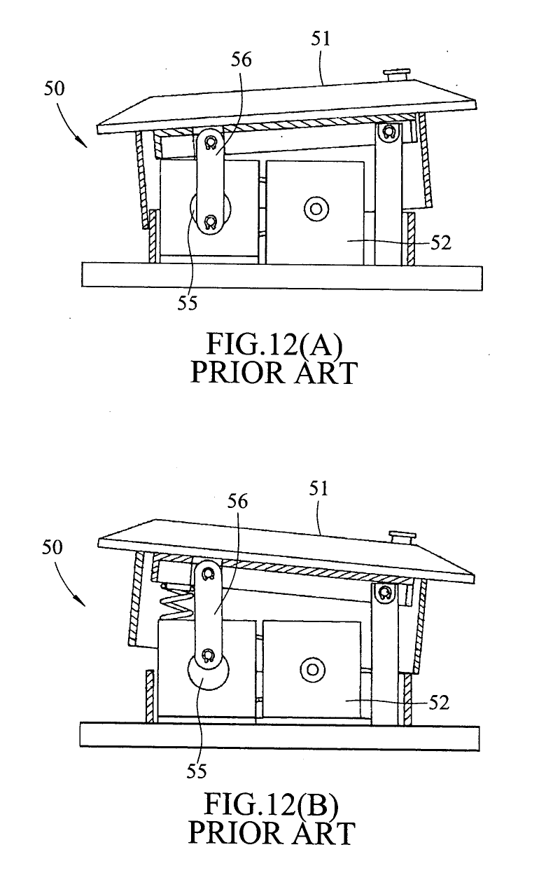

FIG. 9 shows that a plurality of cushion pads 37 can be located beneath the first and second plates 31, 32 so as to absorb impact of the first and second plates 31,32.

While we have shown and described the embodiment in accordance with the present invention, it should be clear to those skilled in the art that further embodiments may be made without departing from the scope of the present invention.

What is claimed is:

1. A body shaking device comprising:
a base;
a driving unit connected to the base and two eccentric shafts being driven by the driving unit, two transmission units connected with the two eccentric shafts respectively and each transmission unit including a first plate and a second plate, the first and second plates being pivoted about two respective pivotal points, a plurality of support members connected to the transmission units, and a case mounted onto the base and supported by the support members.

2. The shaking device as claimed in claim 1, wherein the base includes two first pivotal frames and two second pivotal frames, the first plates of the transmission units are pivotably connected to the first pivotal frames at the pivotal points and the second plates are pivotably connected to the second pivotal frames at the pivotal points, the first plates and the two second plates are located at different height relative to the base, two first connection members each are connected between two respective first ends of the first and second plates.

3. The shaking device as claimed in claim 1, wherein the driving unit includes a motor, a driving shaft driven by the motor and two transmission members, the two eccentric shafts extend from two ends of the driving shaft and the two transmission members each have one end pivotably connected the two eccentric shafts and the other end of each transmission member is pivotably connected to the first plate corresponding thereto at a pivotal point.

4. The shaking device as claimed in claim 3, wherein the motor has an output shaft on which a driving wheel is connected, a belt is connected between the driving wheel and a transmission wheel on the driving shaft.

5. The shaking device as defined in claim 1, wherein a fixed frame is connected to the base and a bearing is connected on the fixed frame, the driving shaft extends through the bearing.

6. The shaking device as claimed in claim 1, wherein the support members each have a second connection member which is pivotably connected to the first plates and the second plates, each second connection member has a flat top.

7. The shaking device as claimed in claim 6, wherein the case is supported on the flat tops of the support members.

8. The shaking device as claimed in claim 1, wherein a plurality of cushion pads are located beneath the first and second plates so as to absorb impact of the first and second plates.

9. The shaking device as claimed in claim 1, wherein the base is composed of a plurality elongate boards which are connected with each other to form a rectangular base.

10. The shaking device as claimed in claim 1, wherein each of the first connection members has a slot defined therethrough and each slot is engaged with an eccentric shaft driven by the motor.
